(19) United States
(12) Patent Application Publication
(10) Pub. No.: US 2007/0046841 A1
(43) Pub. Date: Mar. 1, 2007

(54) Frame assembly for flat screen television

(76) Inventors: Donald Jacobsmeyer, St. Louis, MO (US); Jillian Lopez, Natick, MA (US)

Correspondence Address: POLSTER, LIEDER, WOODRUFF & LUCCHESI, 12412 POWERSCOURT DRIVE SUITE 200, ST. LOUIS, MO, 63131-3615, US

(21) Appl. No.: 11/212,890

(22) Filed: Aug. 26, 2005

(51) Int. Cl. H04N 5/64

(52) U.S. Cl. 348/836

(57) ABSTRACT

A frame assembly (10) for a television (T) mounted on a wall (W) and extending a distance outwardly from the wall. A generally rectangular shaped frame (12) has a decoratively shaped outer contour. The frame has a rectangular shaped central opening (14) whose length and width correspond to that of the television screen (S). An outer section (12a) of the frame adjacent the central opening is sized to fit over and cover an outer shell (C) of the television. A foot (20) is formed at each corner of the frame to support the frame. A base (22) of each foot rests against the wall. The feet space an inner surface (18) of the frame away from the wall to allow air circulation around a backside of the television and conduct heat produced by the television away from the television and the routing of cables.

### CROSS REFERENCE TO RELATED APPLICATIONS

None

### STATEMENT REGARDING FEDERALLY SPONSORED RESEARCH OR DEVELOPMENT

N/A

### BACKGROUND OF THE INVENTION

This invention relates to large viewing size “flat” screen televisions, and more particularly, to a frame assembly for use with such a TV mounted on a wall to provide a decorative appearance to the installation.

Televisions have screens generally rectangular in shape. The size of a screen is measured as the distance from one corner of the screen to its opposite corner along the diagonal extending between the opposite corners. Recently, innovations in television design have resulted in screens which are 37″-42″ in size. In addition, the overall thickness or depth (front-to-back measurement) of televisions has been significantly reduced so that these “flat” screens televisions are becoming increasingly popular.

Because of the decreased thickness of televisions, many are no longer mounted in cabinets or placed on shelves, but rather are wall-mounted. For this installation, a bracket is affixed to a wall, and the television is mounted on the bracket. While this provides greater flexibility in locating the television, the unit itself is plain in appearance and, with the wires dangling from it, can be unsightly, particularly when not in use. This is because the screens of these units are typically surrounded only by a metal or plastic cover or shell that do not necessarily fit in with the décor of a room where the television is installed.

### BRIEF SUMMARY OF THE INVENTION

The present invention is directed to a decorative frame sized to fit over a wall-mounted flat screen television. The frame is a wood, metal, or plastic construction and has an inner, rectangular opening sized to fit over the cover surrounding the screen with the cover abutting against an inner surface of the frame. The size and shape of the opening further corresponds to the dimensions of the screen so when the frame is in place, a viewer looking at the television will not see the cover. The frame has a profile and appearance that blends in with the décor of the room where the television is located. At each corner of the frame are feet which allow the frame to be spaced away from the wall on which the television is mounted. This spacing facilitates sound propagation from the television into a room, as well as the escape of heat generated by the television.

The frame can further have a mirror which fits over the television screen when the frame is installed. The mirror is made of a material that acts transparently when the television is “on”, so people can readily view a program, but is opaque when the television is “off” so to reflect light and make it appear as those there is no television mounted on the wall. For this purpose, the mirror can also be a coated mirror or have a film applied to it. This allows a frame and mirror of one size to be used with televisions of various sizes.

The frame is relatively low cost and easy to install, and can be readily removed if the television needs to be taken down for repair. The frame does not interfere with the use of remote control devices used to switch channels, raise or the volume, or perform other functions.

Other objects and features will be in part apparent and in part pointed out hereinafter.

### BRIEF DESCRIPTION OF THE SEVERAL VIEWS OF THE DRAWINGS

The objects of the invention are achieved as set forth in the illustrative embodiments shown in the drawings which form a part of the specification.

FIGS. 1A and 1B illustrate the wall mounted installation of a flat screen television;

FIG. 2 is a perspective view of a television installed in a room with a frame of the present invention mounted over it;

FIGS. 3A-3C are respective front, top, and side views of one embodiment of the frame;

FIG. 4 is a sectional view of the frame taken along lines 4-4 in FIG. 3A illustrating the profile of the frame;

FIG. 5 is front view of a second embodiment of the frame having a mirror; and

FIG. 6 is front view of a third embodiment of the frame.

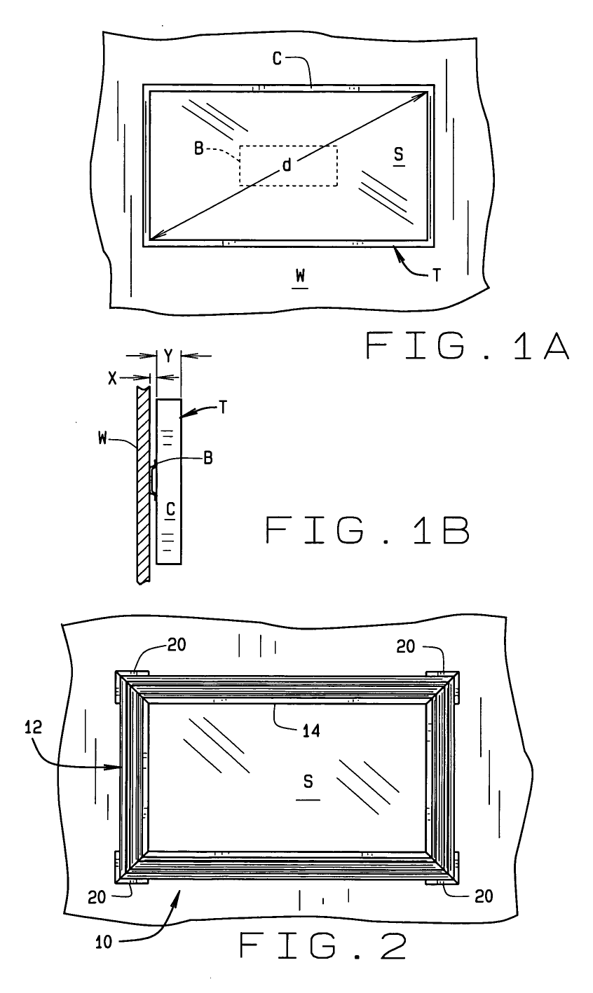

Corresponding reference characters indicate corresponding parts throughout the several views of the drawings.

### DETAILED DESCRIPTION OF INVENTION

The following detailed description illustrates the invention by way of example and not by way of limitation. This description will clearly enable one skilled in the art to make and use the invention, and describes several embodiments, adaptations, variations, alternatives and uses of the invention, including what I presently believe is the best mode of carrying out the invention. As various changes could be made in the above constructions without departing from the scope of the invention, it is intended that all matter contained in the above description or shown in the accompanying drawings shall be interpreted as illustrative and not in a limiting sense.

Referring to FIGS. 1A and 1B, a flat screen television T having a screen S is mounted on a wall W using a bracket B. For convenience, the cables or wires routed to the television set are not shown. In some installations, these are routed up through the wall so as to not be seen. As an industry standard, the size of the television is measured along the diagonal d and is on the order of 37″-42″, although the screen size could be larger or smaller. Bracket B is a conventional metal bracket or the like which extends outwardly from wall W a distance X which is typically 2-3″. The thickness of television T is indicated Y in FIG. 1B and is typically 3-4″. The television is housed in a cover or outer shell C which is made of a high-impact resistance plastic material.

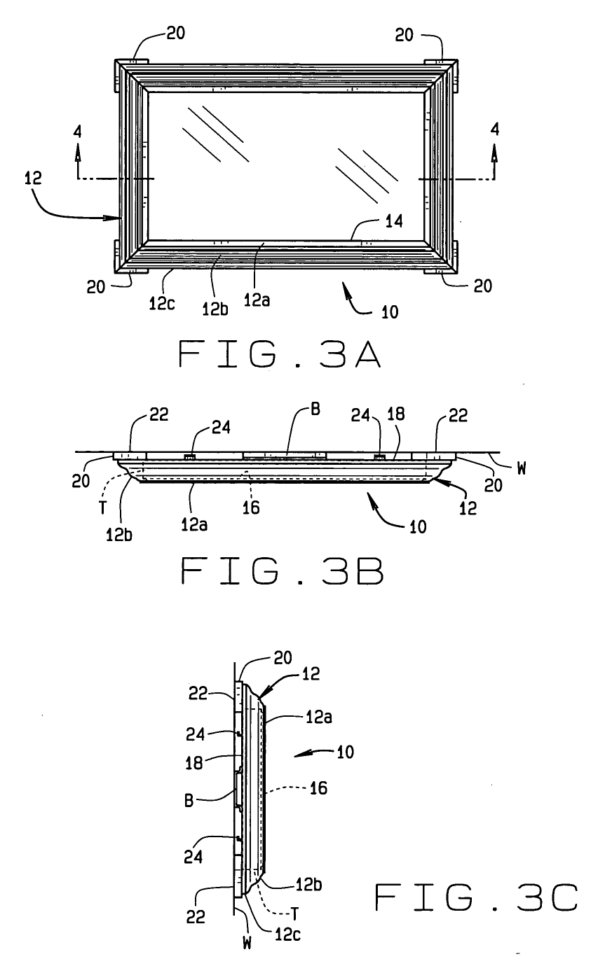

A frame assembly 10 of the present invention is shown in various embodiments in FIGS. 3A-6. The frame assembly first includes a generally rectangular shaped frame 12 having a decoratively shaped outer contour. It will be understood by those skilled in the art that the contours or frame profiles shown in the drawings are illustrative only, and that the frame may be shaped or formed to have other contours or profiles without departing from the scope of the invention.

Frame 12 has a rectangular shaped central opening 14 whose length and width correspond to the length and width of television screen S. As shown in FIGS. 3B and 3C, frame assembly 12 has an outer section 12a comprising a circumferentially extending strip defining central opening 14. Frame section 12a is sized to fit over and cover the outer shell of television T, so only screen S is visible to one looking at the television.

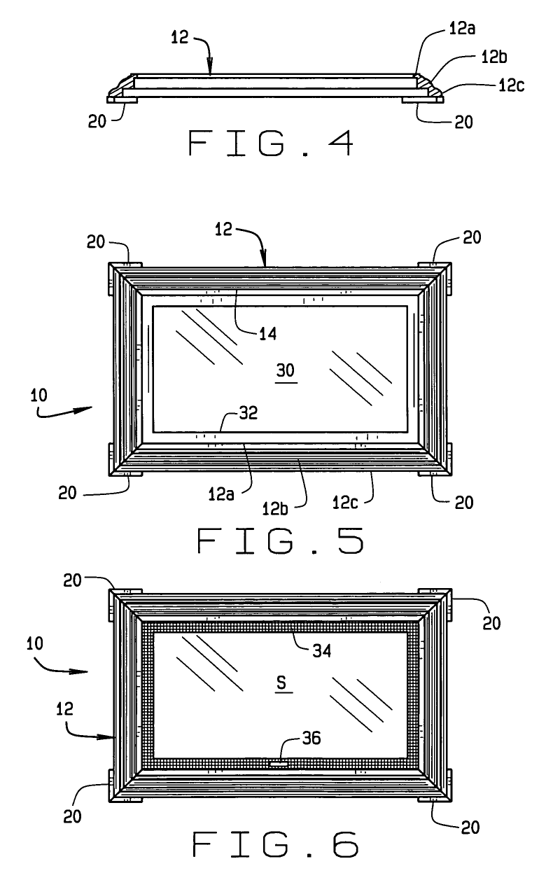

Next, the frame assembly includes a center or intermediate section 12b. The inner end of section 12a extends inwardly of the inner end of section 12b so to form a circumferentially extending shoulder 16 against which the outer surface of cover C rests when the frame is mounted in place. As shown in FIG. 4, the outer surface of section 12b is appropriately contoured to provide a decorative appearance for the frame assembly. The particular contouring depends upon whether the room décor is traditional or modern. Accordingly, the profile can be curved or straight, or be a combination of curved and straight segments.

Frame assembly 12 also has an inner or base section 12c. This section is also contoured. An inner surface 18 of the base section is adjacent wall W when the frame assembly is mounted in place.

A foot 20 is located at each corner of frame 12 to support the frame. A base 22 of each foot rests against wall W. Although not shown, a pad may be affixed to the base to prevent marking frame assembly from marking the wall if the frame is brushed against by someone or moved during cleaning, etc. The feet 20 space inner surface 18 of the frame away from the wall. This has the advantage of allowing air to circulate around a backside of the television and conduct heat produced by the television away from it. It also facilitates propagation of sound from the television into the room. The spacing further allows room for routing cables about the back of the television. For this latter purpose, hooks 24 are attached to surface 18 of frame 12.

Frame assembly 10 is fabricated in a number of ways. For example, each section 12a-12c can be separately made with the pieces then joined together by gluing or some other convenient form of attachment. Or, frame 12 can be produced in a mold so the frame comprises a one-piece integrally formed unit. The feet are made separately from the frame and are attached to the frame prior to installing the assembly to the television. In other embodiments, the feet are molded together with the frame; so, again, a single piece frame assembly is formed. Those skilled in the art will appreciate that the frame assembly is fabricated from a variety of materials. These include carved or shaped pieces of wood, stamped metals such as lightweight aluminum stampings, and different molded plastics, foam, or a urethane.

Next, another embodiment of the invention, as shown in FIG. 5, includes a mirror 30. The mirror has the same height and width dimensions as the dimensions of the television set so the mirror can be mounted in frame 12 by abutting the mirror against shoulder 16. Preferably, the mirror has a border 32 of a black matte appearance. The height of the border can be less or more than that shown in FIG. 5. In addition, the mirror is made of a material which substantially reduces or eliminates reflections so to make the television screen easy to view in ambient light conditions. Thus, even if the sunlight or lamplight strikes the outer surface of the mirror while the television is “on”, a viewer can readily see the televised image. The mirror further is of a material which readily passes the image on screen S without distorting the image, as well as the sound, so the viewer is presented the best picture possible for viewing. Mirror 30 can also have a film or coating applied to it to provide a matte finish. Regardless of the material from which the mirror is made, or the material used to produce border 32, the mirror readily passes rf, laser, or other control signals from a remote control device transmitted to the television to change channels, adjust the volume, etc.

A further advantage of a coated mirror 30 is that it allows a frame and mirror assembly of one size to be used with different size flat screen televisions. This reduces inventory costs for a manufacturer. Also, while frame 12 and mirror 30 can be separately made and then assembled for installation, those skilled in the art will understand that the frame and mirror can be made as a one-piece assembly.

As shown in FIG. 6, in another embodiment of the invention, frame 12 has a border 34 which comprises part of a section 12a′ of the frame. The height of this border is, for example, the same as that of the border 32 for mirror 30. Border 34 can be of a variety of patterns, the pattern shown in FIG. 6 being representative. Regardless of the pattern, the pattern includes an aperture or opening 36 which is positioned over the location on the television set where rf, laser, or other control signals from the remote control device are received by the television so to change viewing channels, adjust the volume, etc.

In view of the above, it will be seen that the several objects and advantages of the present invention have been achieved and other advantageous results have been obtained.

Having thus described the invention, what is claimed and desired to be secured by Letters Patent is:

1. A frame assembly for a wall-mounted television mounted to the wall on a bracket so to extend a distance outwardly from the wall comprising
a generally rectangular shaped frame having a decoratively shaped outer contour, the frame having a rectangular shaped central opening whose length and width correspond to that of the length and width of the television screen, an outer section of the frame adjacent the central opening being sized to fit over and cover an outer shell of the television; and,
a foot located at each corner of the frame to support the frame, a base of each foot resting against the wall, the feet spacing an inner surface of the frame away from the wall to allow air circulation around a backside of the television to conduct heat produced by the television away from the television and the routing of television cables.

2. The frame assembly of claim 1 having an outer section which defines the central opening, a center section, and an inner section which is adjacent the wall when the frame is mounted in place.

3. The frame assembly of claim 2 in which the sections are separately made and then joined together to produce the frame.

4. The frame assembly of claim 2 in which the frame and feet are integrally formed as a one-piece frame.

5. The frame assembly of claim 3 in which the feet are separate from the frame and are attached to the corners of the frame prior to the frame assembly being mounted in place.

6. The frame assembly of claim 4 in which the feet are also integrally formed with the frame.

7. The frame assembly of claim 1 which is made of one of wood, metal, and a plastic including a foam or urethane material.

8. The frame assembly of claim 7 which is made by carving, stamping, or molding the selected material.

9. The frame assembly of claim 1 further including a mirror fitting over the television screen when the frame is mounted in place.

10. The frame assembly of claim 9 in which the mirror has a border of a black matte appearance.

11. The frame assembly of claim 9 in which the mirror is made of a material which substantially reduces or eliminates reflections for the television screen to be readily viewed in ambient light conditions when the television is “on”.

12. The frame assembly of claim 9 in which the mirror is made of a material which readily passes the image on the television screen without distorting the image.

13. The frame assembly of claim 9 in which the mirror readily passes control signals from a remote control device transmitted to the television to control operation thereof.

14. The frame assembly of claim 2 in which the outer section has a border adjacent the opening defined thereby, the border having a decorative pattern.

15. The frame assembly of claim 14 in which the border includes an opening positioned over the location on the television set where control signals from a remote control device are received by the television so to control the operation thereof.

16. The frame assembly of claim 1 further including at least one hook attached to a backside of the frame for holding television wiring.

17. A frame assembly for a wall-mounted television mounted to the wall on a bracket so to extend a distance outwardly from the wall comprising
a generally rectangular shaped frame having a decoratively shaped outer contour, the frame having a rectangular shaped central opening whose length and width correspond to that of the length and width of the television screen, an outer section of the frame adjacent the central opening being sized to fit over and cover an outer shell of the television;
a foot located at each corner of the frame to support the frame, a base of each foot resting against the wall, the feet spacing an inner surface of the frame away from the wall to allow air circulation around a backside of the television to conduct heat produced by the television away from the television and the routing of television cables; and,
a mirror fitting over the television screen when the frame is mounted in place.

18. The frame assembly of claim 17 in which the mirror has a border of a black matte appearance and is made of a material which substantially reduces or eliminates reflections for the television screen to be readily viewed in ambient light conditions when the television is “on”, and which readily passes the image on the television screen without distorting the image.

19. The frame assembly of claim 17 in which the frame and feet are integrally formed as a one-piece frame.

20. The frame assembly of claim 17 in which the feet are separate from the frame and are attached to the corners of the frame prior to the frame assembly being mounted in place.
